(19) United States
(12) Patent Application Publication
(10) Pub. No.: US 2004/0035206 A1
(43) Pub. Date: Feb. 26, 2004

(54) Microelectromechanical sensors having reduced signal bias errors and methods of manufacturing the same

(76) Inventors: Paul A. Ward, Roslindale, MA (US); Jeffrey T. Borenstein, Holliston, MA (US); Christopher M. Lento, Somerville, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/397,577

(22) Filed: Mar. 26, 2003

Related U.S. Application Data
(60) Provisional application No. 60/367,542, filed on Mar. 26, 2002.

(51) Int. Cl. G01P 15/125; G01P 15/14

(52) U.S. Cl. 73/514.32; 73/504.16

(57) ABSTRACT

A capacitive sensor such as a tuning-fork gyroscope or accelerometer having a reduced bias error. The electrical connection of the first capacitive plate to, e.g., a signal measuring device or a voltage source, induces a first voltage difference at the junction. The materials of the second capacitive plate are selected such that its electrical connection to, e.g., a signal measuring device or a voltage source, induces a second voltage difference that substantially offsets the first voltage difference and reduces the bias error. One embodiment forms the capacitive plates, e.g., a proof mass and a sense plate, from substantially identical doped semiconductors.

### REFERENCE TO RELATED APPLICATIONS

This application claims the benefit of U.S. Provisional Patent Application No. 60/367,542, filed on Mar. 26, 2002, and entitled “Silicon Tuning-Fork Gyroscope with Silicon Sense Plates,” the entire contents of which are incorporated by reference herein.

### FIELD OF THE INVENTION

The present invention relates generally to microelectromechanical (MEMS) motion sensors and, in particular, to MEMS sensor structures having reduced signal bias errors.

### BACKGROUND OF THE INVENTION

MEMS motion sensors (e.g., accelerometers and tuning-fork gyroscopes) are used in a wide variety of military and commercial applications that demand high levels of precision. For example, gyroscopes for commercial applications may be required to have accuracy approaching 1 degree/hour bias over a wide temperature range.

Many MEMS motion sensors share a similar principle of operation. The sensors are formed from at least one pair of plates that may be electrostatically charged, operating as a capacitor. Moving the sensor causes a change in the “sense gap”, i.e., the distance between the plates, changing the capacitance value of the sensor. This measured capacitance value, subjected to appropriate post-measurement processing, indicates the motion of the sensor.

One such MEMS sensor, a tuning-fork gyroscope, has at least one set of capacitive plates. One plate, the proof mass, is fabricated from silicon. The opposing capacitive plate, the sense plate, has traditionally been formed from a metallic element. In operation, the sense plate is connected to a voltage source and the proof mass is free to oscillate relative to the sense plate. The distance between the sense plate and the proof mass defines the sense gap. Rotating the gyroscope changes the size of the sense gap, changing the capacitance of the plate pair and inducing a current flowing into or out of the proof mass. Measurement electronics measure the current and use the resulting measurement to calculate an inertial rate for the sensor.

The aforementioned tuning fork gyroscope, having a silicon proof mass and a metallic sense plate, suffers from a significant bias error, typically on the order of several hundred millivolts. The bias error may overwhelm the signal from the proof mass, reducing the overall precision of the tuning fork gyroscope and limiting the minimum inertial rate that the sensor may resolve.

Prior art methods for eliminating the bias error at the measurement stage have been complicated the tendency of the bias error to vary with the sensor's temperature. Methods that, for example, introduce an offset to counter the bias error are frustrated as the bias error varies with temperature. Many gyroscope applications require consistent performance across large temperature ranges.

Other attempts to reduce the bias error by modifying the tuning fork gyroscope's structure have varied the composition of the sense plate (e.g., from gold to platinum or palladium), altered the doping of the silicon forming the proof masses, or both. The results of these attempts have typically been dwarfed by the magnitude of the bias error, e.g., effecting a reduction of 0.25-0.29 eV.

Another MEMS sensor operating according to a variable capacitance principle similar to that of the tuning-fork gyroscope is the “teeter-totter” or “see-saw” accelerometer. A see-saw accelerometer includes a beam suspended over a substrate. A flexural fulcrum is placed off-center to support the beam such that the beam's length on one side of the fulcrum is longer than the beam's length on the other side of the fulcrum.

The accelerometer's beam performs the role of the proof mass and operates as one plate of a capacitor. At least one sense plate is attached to the substrate beneath the beam, each sense plate acting as the second plate in a capacitive pair. The distance between the beam and each sense plate in turn defines a sense gap.

In operation, the sense plate is energized with a periodic electric signal, such as a sine wave or a square wave, causing a corresponding baseline cyclical current flow into and out of the beam. The beam is, in turn, electrically connected to a signal measuring device that measures the baseline current and detects deviations in the current flow from the established baseline.

Since the beam is balanced off-center by the fulcrum, the application of an acceleration having a vector component that is orthogonal to the plane of the substrate results in differing torques being applied to each end of the beam. The unbalanced torque results in a net rotation of the beam about the fulcrum, such that one end of the beam approaches at least one sense plate, decreasing the associated sense gap(s). On the other side of the fulcrum, the other end of the beam recedes from at least one sense plate, increasing the associated sense gap(s). The changes in the sense gap sizes alters the capacitance of the sensor, resulting in fluctuations in the current flowing in and out of the proof mass. These current fluctuations deviate from the established baseline current and are indicative of acceleration.

See-saw accelerometers and other capacitive sensors having metal sense plates suffer from a bias error similar to that experienced by silicon tuning-fork gyroscopes having metal sense plates.

### SUMMARY OF THE INVENTION

The present invention provides capacitive MEMS sensors such as accelerometers and gyroscopes that provide greatly reduced bias errors relative to prior art capacitive sensor systems.

In one aspect, the invention provides a sensor that includes a first capacitor plate that is formed from a first material and that can be electrically connected to an energy source at a first junction. The first junction gives rise to a potential difference between the first capacitor plate and the energy source. The sensor also includes a second capacitor plate that is made from a second material and can be connected to a signal measuring device at a second junction. The second capacitor plate is separated from the first capacitor plate by a sense gap and provides, to the signal measuring device, a signal that is indicative of changes to the size of the sense gap. The second junction gives rise to a potential difference between the second capacitor plate and the signal measuring device that substantially offsets the potential difference at the first junction.

In one embodiment, the first material is a semiconductor and the second material is selected so that the potential difference between the first material and the energy source is substantially offset by the potential difference between the second material and the signal measuring device.

In another embodiment, the first material is a semiconductor and the second material is a semiconductor selected so that the potential difference between the first material and the energy source is substantially offset by the potential difference between the second material and the signal measuring device. In one variant of this embodiment, the first material is doped at substantially the same level as the second material. In another variant, the first material and the second material are doped with substantially the same dopant. In still another variant, the first material and the second material have substantially the same crystalline structure. In a further variant, the first material and the second material are both silicon based.

In one embodiment, the first capacitor plate and the second capacitor plate have substantially the same shapes. In another embodiment, the first capacitor plate and the second capacitor plate have substantially the same mass. In still another embodiment, the first capacitor plate and the second capacitor plate have substantially the same volume.

In one embodiment, the first capacitor plate is a sense plate of a tuning-fork gyroscope. In another embodiment, the second capacitor plate is a proof mass of a tuning fork gyroscope. In still another embodiment the first capacitor plate is a sense plate of an accelerometer. In yet another embodiment the second capacitor plate is a proof mass of an accelerometer.

In another aspect, the present invention provides a method of measuring a parameter of motion. A first capacitor plate is provided that is formed from a first material and that is electrically connected to an energy source at a first junction. The first junction gives rise to a potential difference between the first capacitor plate and the energy source. A second capacitor plate, formed from a second material, is provided that is spaced apart from the first capacitor plate by a sense gap and is electrically connected to a signal measuring device at a second junction. The second capacitor plate provides a signal indicative of changes in the size of the sense gap. The second junction gives rise to a potential difference between the second capacitor plate and the signal measuring device. The potential differences provided at the first and second junctions are substantially equal. Measuring the signal indicative of changes in the size of the sense gap permits the measurement of a parameter of motion.

In still another aspect, the present invention provides a tuning fork gyroscope having at least one sense plate made from a first material that is electrically connectable to an energy source at a first junction. The first junction gives rise to a potential difference between the sense plate and the energy source. The gyroscope further includes at least one proof mass, made from a second material and spaced at a distance from the sense plate by a sense gap, that is electrically connectable to a signal measuring device at a second junction. The proof mass provides a signal indicative of changes in the size of the sense gap. The second junction gives rise to a contact potential difference between the proof mass and the signal measuring device. The potential difference at the first junction substantially offsets the potential difference at the second junction.

In another aspect, the present invention provides an accelerometer having an elongated proof mass, made of a first material, that is supported by a fulcrum in an unbalanced fashion at a distance from at least one sense plate, made of a second material, by a sense gap. The elongated proof mass is electrically connectable to a signal measuring device at a first junction and provides an electrical signal indicative of changes to the size of the sense gap. The first junction gives rise to a potential difference between the elongated proof mass and the signal measuring device. The sense plate is electrically connectable to an energy source at a second junction. The second junction gives rise to a potential difference between the sense plate and the energy source. The potential difference at the first junction is substantially offset by the potential difference at the second junction.

In yet another aspect, the present invention provides a sensor having a proof mass formed from a first semiconductor material that is configured for oscillation in a first drive plane and for motion in a direction substantially orthogonal to the drive plane. The sensor further includes a proof mass contact location for electrically connecting to the first proof mass. The sensor also comprises a sense plate formed from a second semiconductor material that is spaced from the proof mass by a sense gap. In addition, the sensor has a sense plate contact location for electrically connecting to the sense plate.

In one embodiment, the first and second semiconductor materials have substantially the same doping levels. In another embodiment, the first and second semiconductor materials are doped with substantially the same materials. In yet another embodiment, the first and second semiconductor materials are the same material. In still another embodiment, the proof mass and the sense plate have substantially the same shape. In a further embodiment, the proof mass and the sense plate have substantially the same mass. In an additional embodiment, the first and second semiconductor materials have substantially the same crystalline structure. In another embodiment, the first and second semiconductor materials have substantially the same work function. In a further embodiment, the first and second semiconductor materials are silicon-based.

In still another aspect, the present invention provides a device for sensing a parameter based at least in part on a change in capacitance of the device and for generating a signal indicative thereof. The device includes a first electrical contact formed from a first material for electrically coupling the device to an energy source via an energy source contact formed from a second material. The device further includes a second electrical contact formed from a third material for electrically coupling the device to a signal measuring device via a signal measuring device contact formed from a fourth material. The first, second, third, and fourth materials are selected to reduce any electrical bias that may be caused by the contacts.

### BRIEF DESCRIPTION OF THE DRAWINGS

The objects and features of the invention may be better understood with reference to the drawings described below and the claims. The drawings are not necessarily to scale, emphasis instead generally being placed upon illustrating the principles of the invention. In the drawings, like numerals are used to indicate like parts throughout the various views.

FIG. 1 is a side view of a capacitive sensor system according to one embodiment of the invention;

FIG. 2 is a overhead view of a silicon tuning-fork gyroscope with silicon sense plates in accord with another embodiment of the invention;

FIG. 3 depicts cross-sectional views of a first fabrication phase of a silicon tuning-fork gyroscope in accord with the present invention;

FIG. 4 is a flowchart identifying the steps of the first fabrication phase depicted in FIG. 3;

FIG. 5 depicts cross-sectional views of a second fabrication phase of a silicon tuning-fork gyroscope in accord with the present invention;

FIG. 6 is a flowchart identifying the steps of the second fabrication phase depicted in FIG. 5;

FIG. 7 depicts cross-sectional views of a third fabrication phase of a silicon tuning-fork gyroscope in accord with the present invention;

FIG. 8 is a flowchart identifying the steps of the third fabrication phase depicted in FIG. 7; and

FIG. 9 is a side view of a see-saw accelerometer according to another embodiment of the invention.

### DETAILED DESCRIPTION OF ILLUSTRATIVE EMBODIMENTS

In brief overview, the present invention provides capacitive sensors having reduced bias errors by offsetting contact potentials arising within the sensor structure. More specifically, the capacitive plates of the sensor create differences in electrovoltaic potential where the plates are joined, e.g., to metallic wires. By appropriately selecting the materials forming the sensor structure, the contact potential caused by the junction with a first plate of the sensor offsets the contact potential caused by the junction with a second plate of the sensor, substantially eliminating a major source of bias error in the sensor. This technique may be applied to capacitive sensors such as tuning-fork gyroscopes and see-saw accelerometers by fabricating the sense plates and the proof masses of these sensors from substantially-identical doped semiconductors.

A potential difference (i.e., a “contact potential”) exists at a junction between two materials having different work functions (i.e., ionization energies). For example, the interface between a metal (such as copper) and a semiconductor (such as doped silicon) gives rise to a electrovoltaic potential. The same is true of an interface between a metal (such as copper) and a second, different metal (such as platinum).

In typical capacitive sensors having at least one pair of capacitive plates—such as MEMS tuning—fork gyroscopes—a semiconductor-metal junction is created where a doped silicon capacitor plate meets a copper lead, creating a first contact potential. A metal-metal junction is created with another, metallic capacitive plate, generating a second, substantially smaller contact potential than the first contact potential at the semiconductor-metal junction.

Applicants have discovered that a substantial portion of the bias error in these capacitive sensors is a result of the difference in magnitude between these asymmetrical contact potentials. Applicants have further discovered that the fabrication of a capacitive sensor so that the contact potentials arising from the junctions with the individual capacitor plates substantially offset each other greatly reduces—if not eliminates—the bias error that hinders typical capacitive sensors.

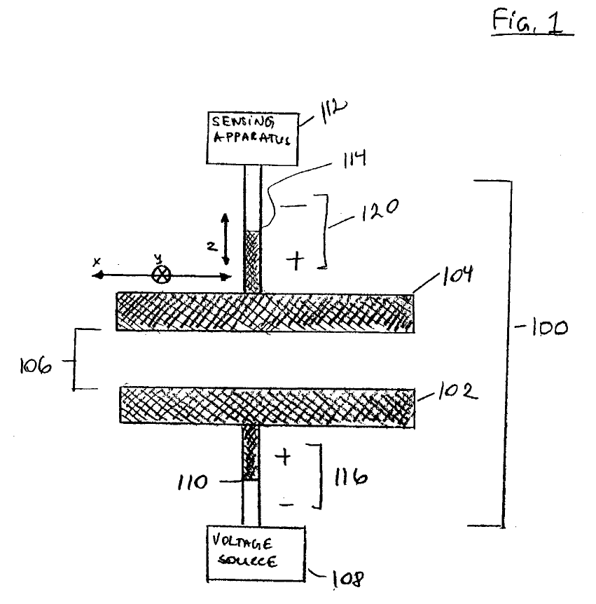

FIG. 1 is a side view of a capacitive sensor system according to one embodiment of the invention. The sensor 100 includes a first capacitor plate 102 (“sense plate”) and a second capacitor plate 104 (“proof mass”). The distance between the sense plate 102 and the proof mass 104 defines a sense gap 106.

The sense plate 102 is electrically connectable to an energy source 108, such as a voltage source, using a metal lead or metallized trace. The metallization contacts the sense plate 102 at a first junction 110, inducing a contact potential 116 at the junction 110. In typical versions of analogous capacitive sensors, the sense plate 102 would be a metallic electrode.

The second capacitor plate (“proof mass”) 104 is electrically connectable to a signal measuring device 112 using a metal lead or metallized trace. The metallization contacts the proof mass 104 at a second junction 114. In typical versions of similar capacitive sensors, the proof plate 104 is made from a semiconductor, such as highly-doped silicon. The contact between the highly-doped silicon and the metalization results in a significant contact potential 120 at the junction 114.

In operation, the sense plate 102 is connected to the energy source 108, for example, a voltage source, creating a voltage across the capacitor plates 102 and 104. Motion of the sensor 100 results in an increase or a decrease in the size of the sense gap 106 between the capacitor plates 102, 104. Changes in the size of the sense gap 106 result in changes to the capacitance of the sensor 100, inducing a current flow either into or out of the proof mass 104. The signal measuring device 112 measures the current flow involving the proof mass 104, thereby detecting the motion of the sensor 100.

In one embodiment of a sensor 100 in accord with the present invention, the materials for the sense plate 102 and the proof mass 104 are chosen such that the junctions 110, 114 between the sense plate 102 and the proof mass 104 and their respective metallizations generate contact potentials 116, 120 that substantially offset one another. In one embodiment, for example, both the sense plate 102 and the proof mass 104 are highly-doped silicon; then the contact potentials 116, 120 are substantially identical in magnitude and substantially cancel each other out, eliminating the bias error term. Other materials, either individually or in combination, may be utilized for the sense plate 102 and the proof mass 104, provided that the contact potentials 116, 120 generated at the junctions 110, 114 are substantially equal and opposite. Additionally, when the ambient temperature of the sensor 100 varies significantly, the materials of the sense plate 102 and the proof mass 104 should be selected so that the contact potentials 116, 120 vary with changes in the ambient temperature of the sensor 100 at substantially the same rate.

In some exemplary embodiments, the sense plate 102 and the proof mass 104 also share substantially one or more of the same shape, mass, or volume in order to more closely match their contact potentials 116, 120. The metallization connecting with the sense plate 102 or the proof mass 104 may be, for example, gold, palladium, or platinum.

Tuning-Fork Gyroscope

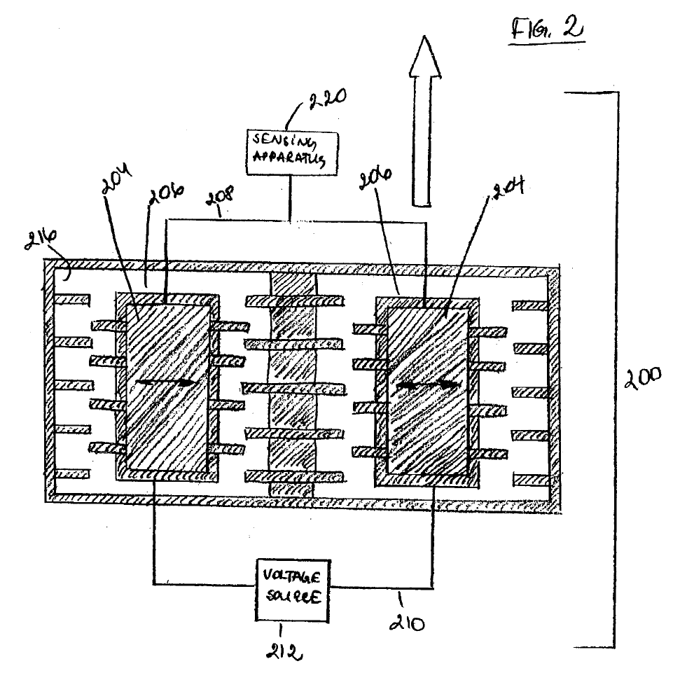

FIG. 2 presents an overhead view of another embodiment of the invention, being a tuning-fork gyroscope 200. Tuning-fork gyroscopes 200 generally have at least two proof masses 204, flexurally mounted within a drive frame (together the “proof mass assembly”), on either side of an axis of rotation. The distance between each proof mass 204 and its respective sense plate 206 defines a sense gap (not shown). Rotation of the sensor 200 about the axis changes the width of the sense gap, inducing currents into or out of the proof masses 204 that are subsequently detected by a signal measuring device 220. The proof masses 204 are typically connected in parallel to the signal measuring device 220 such that the currents into or out of the proof masses 204 combine to yield a larger, common mode signal for application to the input of the signal measuring device 220. As such, any bias errors created across the sense gaps between the proof masses 204 and their respective sense plates 206 combine to exacerbate the total bias error.

In a tuning-fork gyroscope 200 built according to one embodiment of the invention, the gyroscope's proof masses 204 are formed from a semiconductor, e.g., silicon. The sense plates 206 are made of a material so that any contact potential created at the junction of the gyroscope's proof masses 204 with metallization 208 is substantially offset by the contact potential created by the junction of the sense plates 206 with the metallization 210 connecting the sense plates 206 to the energy source 212. For example, the sense plates 206 may be made of substantially the same semiconductor, such as highly doped silicon, as the proof masses 204. As a result, bias errors in the gyroscope 200 are greatly reduced or eliminated. In additional embodiments, at least one of the shape, mass, and volume of the proof masses 204 and the sense plates 206 match to facilitate the offset of the potentials.

Gyroscope Fabrication Process

Gyroscope sensors having silicon proof masses and silicon sense plates in accord with the present invention may be fabricated using any of a variety of techniques with several types of silicon. Since this invention provides contacts with substantial identical and offsetting potentials, it is desirable for the manufacturing process to generate sense plate and proof masses contacts that are subsantially similar, e.g., in size, volume, or mass, as discussed above. Accordingly, the exemplary fabrication process discussed here utilizes the same source of silicon for the sense plates as is used to construct the gyroscope.

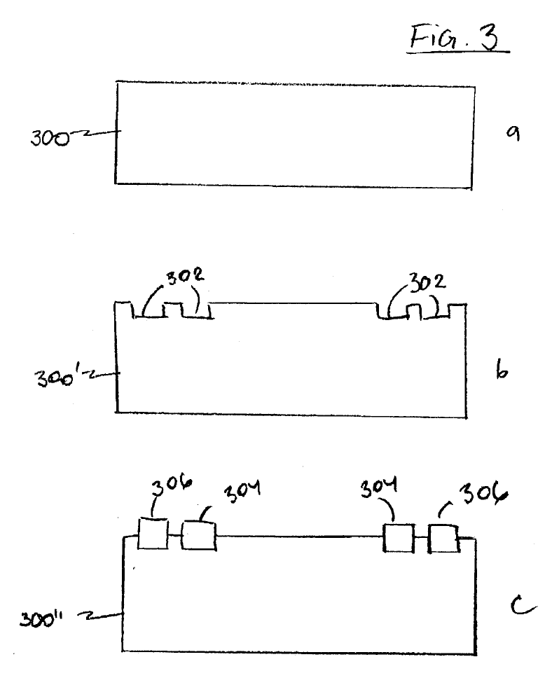

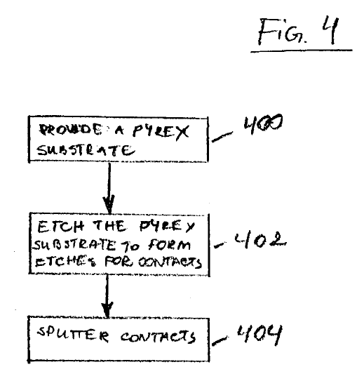

The sequence of steps forming an exemplary manufacturing process in accord with the present invention is illustrated in FIGS. 3-8. The manufacturing process begins with the fabrication of the glass substrate described in FIGS. 3 and 4. First, a pyrex substrate 300 is provided as shown in FIG. 3a (Step 400). The pyrex substrate 300 is then etched (Step 402), defining etchings 302 into which bonding materials may be deposited, resulting in the etched pyrex wafer 300′ of FIG. 3b. Metal sense plate contacts 304 and proof mass assembly bond pads 306 are sputtered into the etchings 302 (Step 404) to yield the pyrex substrate 300″ of FIG. 3c.

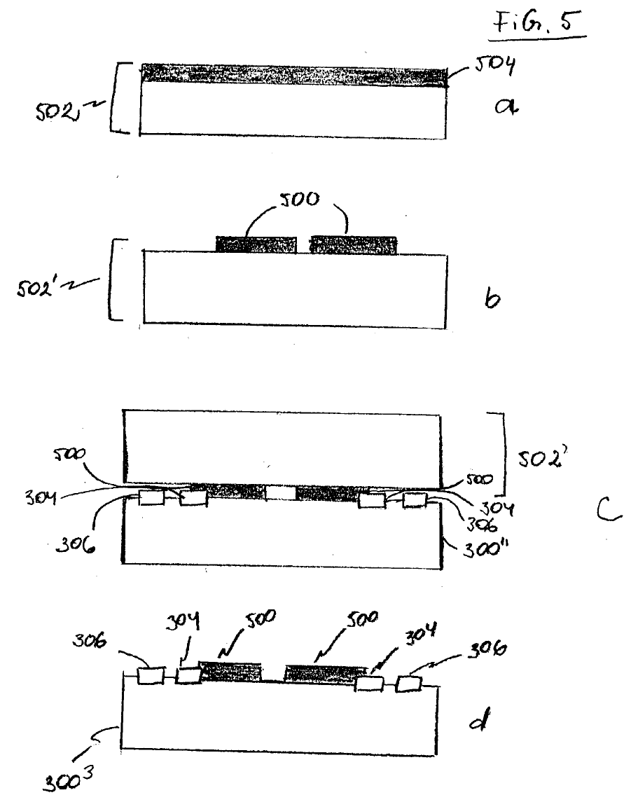

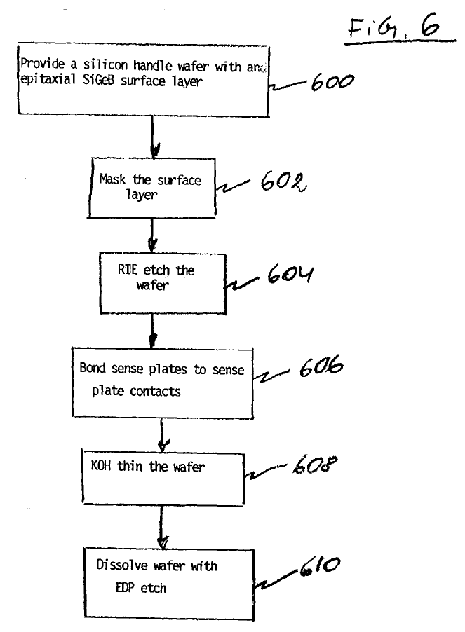

FIGS. 5 and 6 illustrate an exemplary method for the fabrication and bonding of the silicon sense plates 500 to the pyrex substrate 300″ in accord with the present invention. A low-doped silicon handle wafer 502 (“handle wafer”) is provided as shown in FIG. 5a (Step 600). The handle wafer 502 has, in this embodiment, an epitaxial Silicon Germanium Boron (SiGeB) surface layer (“epi layer”) 504 having a thickness of roughly 0.5-1.0 microns, so that the doping concentration of the epi layer 504 is high enough to stand up during the Ethylene Diamine Pyrocatechol (EDP) etch (Step 610, discussed below). The epi layer 504 is masked to form the sense plates 500 (Step 602), and the silicon is etched through the epi layer 204 and into the bulk using a Reactive Ion Etching (RIE) process (Step 604) yielding the handle wafer 502′ of FIG. 5b. The etch profile and the depth may be varied within typical boundary parameter values, as the boron etch stop provides the definition. The silicon sense plates 500 are then anodically bonded to the sense plate contacts 304 of FIG. 3c as depicted in FIG. 5c (Step 606). A seal ring may be included on the maskset for the silicon sense plates, so that the handle wafer 502′ may be partially removed by KOH thinning (Step 608) rather than utilizing EDP for the entire removal process. The EDP etch then dissolves the remainder of the excess handle wafer 502′ (Step 610), leaving the two sense plates 500 bonded with their sense plate contacts 304 as depicted in FIG. 5d.

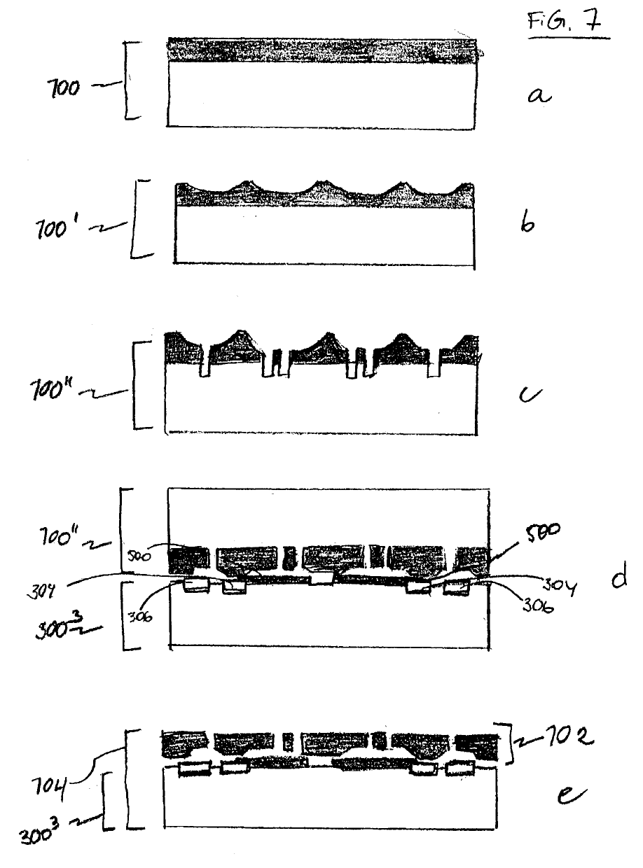

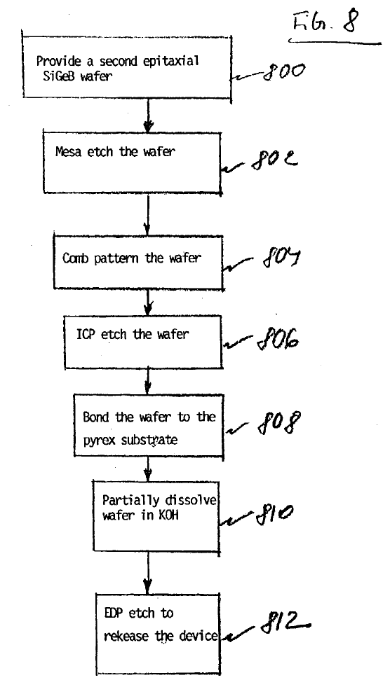

The final stage of fabrication in this embodiment, i.e., fabricating the proof mass assembly and assembling the components, is depicted in FIGS. 7-8. A second SiGeB wafer 700 for the TFG14-14 (“second epi wafer”) is provided (Step 800) as depicted in FIG. 7a. The second epi wafer 700 is mesa-etched (Step 802) resulting in the second epi wafer 700′ of FIG. 8b.

Next, the second epi wafer 700′ is comb patterned (Step 804), resulting in the second epi wafer 700″ of FIG. 7c. The second epi wafer 700″ is then Inductively-Coupled Plasma (ICP) etched (Step 806), electrical connections are created using standard lithography techniques, and the second epi wafer 700″ is anodically bonded (Step 808) to the glass wafer 300³ with silicon sense plates 500 resulting in the combined glass wafer 3003 and second epi wafer 700″ as depicted in FIG. 7d. The second epi wafer 700″ is then partially dissolved in KOH (Step 810) and the proof mass assembly 702 is released from the second epi wafer 300³ during a further EDP etch (Step 812), resulting in the silicon tuning-fork gyroscope with silicon sense plates 704 depicted in FIG. 7e.

Accelerometer

As with the gyroscope, constructing an accelerometer having silicon proof masses and metallic sense plates typically results in an unbalanced contact potential across the sensor's sense gaps. The imbalance in contact potential results in an inherent torque on either end of the beam that is proportional to the beam's contact potential, creating a bias error. The impact of the contact potential bias is:

$$F = \frac{1}{2} \frac{ⅆ C}{ⅆ x} {v}^{2} \qquad ( Eq . 1 )$$

That is, the force F creates a torque that is proportional to the square of the contact potential, v. C is the capacitance of the proof mass-sense plate system, which varies with the change in distance of the sense gap, x.

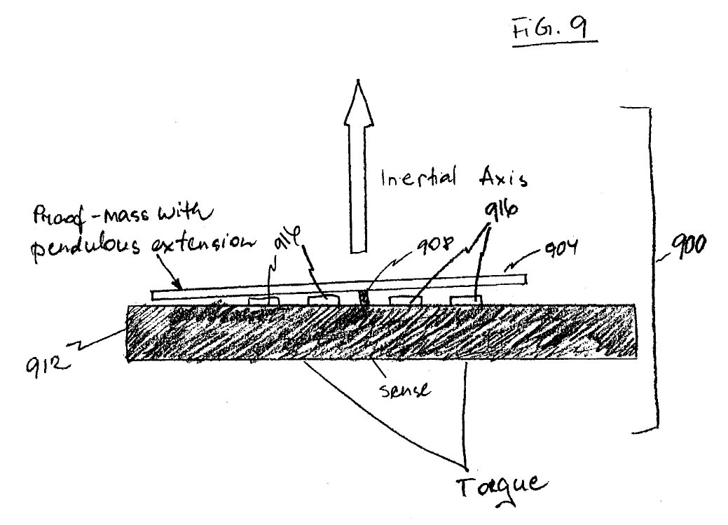

FIG. 9 depicts an exemplary see-saw accelerometer 900, constructed according to one embodiment of the invention, that provides a reduced—if not wholly eliminated—contact potential bias error. A semiconductor beam 904 is supported by a flexural connection 908 over a substrate 912. The flexural connection 908 operates as a fulcrum about which the beam 904 may rotate. The beam 904 is connected via metallization to a signal measuring device (not shown). The substrate 912 holds at least two sense plates 916, one located under either end of the beam 904. The sense plates 916 are connectable to a signal generating device via metallization (not shown). In some embodiments, the signal generating device outputs a cyclical electrical signal, such as a sine or square wave, through the metallization.

The junctions of the beam and the sense plates with their respective metallizations each creates a contact potential at the junction. The sense plates are formed from a material chosen such that the contact potential generated at the sense plate-metallization junction substantially offsets the contact potential generated at the proof mass-metallization junction. For example, the proof masses 904 and the sense plates 916 may be fabricated from silicon having substantially the same doping.

Fabrication Process

The fabrication process of an accelerometer in accord with an embodiment of the present invention is similar to the fabrication process discussed above with respect to the tuning-fork gyroscope embodiment. To summarize, metallization contacts are deposited on an etched pyrex substrate. Sense plates are etched out of SeGeB wafer, anodically bonded to the substrate, and the wafer is dissolved via KOH and EDP etching. A second SeGeB wafer is mesa etched, comb patterned, and ICP etched to form the beam portion of the accelerometer. The beam portion is then anodically bonded to the pyrex substrate and the excess wafer is dissolved via KOH and EDP etching.

One skilled in the art will recognize that the invention described above may be applied to other sensors that suffer from contact potential biases. Furthermore, one skilled in the art would recognize that silicon is only one of a group of semiconductors suited to the construction of the sensors described above.

Therefore, while the invention has been particularly shown and described with reference to particular illustrated embodiments, it should be understood by skilled artisans that various changes in form and detail may be made therein without departing from the spirit and scope of the invention.

What is claimed is:

1. A sensor comprising:
a first capacitor plate formed from a first material, electrically connectable to an energy source at a first junction, the first junction giving rise to a potential difference between the first capacitor plate and the energy source, and
a second capacitor plate, spaced from the first capacitor plate by a first sense gap, and being electrically connectable to a signal measuring device at a second junction for providing a signal indicative of changes in a size of the sense gap to the signal measuring device, the second junction giving rise to a potential difference between the second capacitor plate and the signal measuring device; and
the potential difference at the first junction substantially offsetting the potential difference at the second junction.

2. The sensor of claim 1 wherein the first material is a semiconductor and the second material is selected such that the potential difference between the first material and the energy source is substantially offset by the potential difference between the second material and the signal measuring device.

3. The sensor of claim 2 wherein the first material is a semiconductor and the second material is a semiconductor selected such that the potential difference between the first material and the energy source is substantially offset by the potential difference between the second material and the signal measuring device.

4. The sensor of claim 3 wherein the first material is doped at substantially the same level as the second material.

5. The sensor of claim 3 wherein the first material and second material are doped with substantially the same dopant.

6. The sensor of claim 3 wherein the first material and second material have substantially the same crystalline structure.

7. The sensor of claim 3 wherein the first material and the second material are both silicon based.

8. The sensor of claim 1 wherein the first capacitor plate and the second capacitor plate have substantially the same shapes.

9. The sensor of claim 1 wherein the first capacitor plate and the second capacitor plate have substantially the same mass.

10. The sensor of claim 1 wherein the first capacitor plate and the second capacitor plate have substantially the same volume.

11. The sensor of claim 1 wherein the first capacitor plate is a sense plate of a tuning fork gyroscope.

12. The sensor of claim 1 wherein the second capacitor plate is a proof mass of a tuning fork gyroscope.

13. The sensor of claim 1 wherein the first capacitor plate is a sense plate of an accelerometer.

14. The sensor of claim 1 wherein the second capacitor plate is a proof mass of an accelerometer.

15. A method of measuring a parameter of motion comprising the following steps:
providing first capacitor plate formed from a first material, electrically connected to an energy source at a first junction, the first junction giving rise to a potential difference between the first capacitor plate and the energy source
providing a second capacitor plate, spaced from the first capacitor plate by a first sense gap, and being electrically connected to a signal measuring device at a second junction for providing a signal indicative of changes in a size of the sense gap to the signal measuring device, the second junction giving rise to a potential difference between the second capacitor plate and the signal measuring device
providing for the potential difference at the first junction to be substantially equal to the potential difference at the second junction; and
measuring the signal indicative of changes in a size of the sense gap to measure a parameter of motion.

16. A tuning fork gyroscope comprising
at least one sense plate that is made from a first material, is electrically connectable to an energy source at a first junction, the first junction giving rise to a potential difference between the sense plate and the energy source;
at least one proof mass, made from a second material, spaced at a distance from the sense plate by a sense gap, for providing a signal indicative of changes in the size of the sense gap, and electrically connectable to a signal measuring device at a second junction, the second junction giving rise to a contact potential between the proof mass and the signal measuring device;
the potential difference at the first junction substantially offsets the potential difference at the second junction.

17. An accelerometer comprising
an elongated proof mass, made of a first material, supported by a fulcrum in an unbalanced fashion at a distance from at least one sense plate by a sense gap, providing an electrical signal indicative of changes to the size of the sense gap, the proof mass being electrically connectable to a signal measuring device at a first junction, the first junction giving rise to a potential difference between the elongated proof mass and the signal measuring device;
the sense plate, made from a second material, electrically connectable to an energy source at a second junction, the second junction gives rise to a potential difference between the sense plate and the energy source; and
the potential difference at the first junction is substantially offset by the potential difference at the second junction.

18. A sensor comprising:
a first proof mass formed from a first semiconductor material, configured for oscillation in a first drive plane, motion in a direction substantially orthogonal to the first drive plane, and including a first proof mass contact location for electrically connecting to the first proof mass; and
a first sense plate spaced from the first proof mass by a first sense gap, having a first sense plate contact location for electrically connecting to the first sense plate, and formed from a second semiconductor material.

19. The sensor of claim 18, wherein the first and second semiconductor materials have substantially the same doping levels.

20. The sensor of claim 18, wherein the first and second semiconductor materials are doped with substantially the same materials.

21. The sensor of claim 18, wherein the first and second semiconductor materials are the same material.

22. The sensor of claim 18, wherein the first proof mass and the first sense plate have substantially the same shape.

23. The sensor of claim 18, wherein the first proof mass and the first sense plate have substantially the same mass.

24. The sensor of claim 18, wherein the first and second semiconductor materials have substantially the same crystalline structure.

25. The sensor of claim 18, wherein the first and second semiconductor materials have substantially the same work function.

26. The sensor of claim 18, wherein the first and second semiconductor materials are silicon-based.

27. A device for sensing a parameter based at least in part on a change in capacitance of the device and for generating a signal indicative thereof, the device comprising,
a first electrical contact formed from a first material for electrically coupling the device to an energy source via an energy source contact formed from a second material;
a second electrical contact formed from a third material for electrically coupling the device to a signal measuring device via a signal measuring device contact formed from a fourth material,
wherein the first, second, third and fourth materials are selected to reduce contact bias.
